(19) United States
(12) Patent Application Publication
(10) Pub. No.: US 2006/0130022 A1
(43) Pub. Date: Jun. 15, 2006

(54) Method to integrate biometric functionality into a host software application with runtime and compilation independence

(76) Inventors: A. Mizan Rahman, Atlanta, GA (US); Khondker F. Sultana, Atlanta, GA (US); Michael N. Trader, Atlanta, GA (US)

Correspondence Address: Wilson Daniel Swayze, Jr, 3804 Clearwater Ct., Plano, TX, 75025, US

(21) Appl. No.: 11/274,738

(22) Filed: Nov. 15, 2005

Related U.S. Application Data
(60) Provisional application No. 60/628,441, filed on Nov. 16, 2004.

(51) Int. Cl. G06F 9/45

(52) U.S. Cl. 717/140; 717/100; 717/148

(57) ABSTRACT

A method is proposed to integrate any form of biometric technology (e.g. fingerprint/face/iris/retina recognition, hand geometry, etc.) into a host software application without requiring runtime or software code compilation between the host and biometric software. The biometric software runs as a separate executable, independent of the host software, and communicates with the host software over a protocol supported by the host and biometric software operating system. The biometric software utilized by the host software can be substituted with another biometric software type with very little development effort. Hence, the proposed method will enable commercial software providers to rapidly integrate various biometric technologies without: a) requiring an extensive amount of knowledge and development resources regarding the selected biometric technology; b) having to compile the host software with the biometric software, which otherwise creates a burdensome development, maintenance, and support environment. This translates into decreased costs of integration, frees internal resources, and accelerates the deliverance of highly valuable biometric technology to the mainstream marketplace.

### CROSS-REFERENCE TO RELATED APPLICATIONS

### PRIORITY

This application claims priority based on 35 USC 119 from U.S. Provisional Patent Application No. 60/628,441, filed Nov. 16, 2004, entitled BIO-PLUGIN, A METHOD TO INTEGRATE BIOMETRIC FUNCTIONALITY INTO A HOST SOFTWARE APPLICATION WITH RUNTIME AND COMPILATION INDEPENDENCE naming A. Rahman and K. Sultana as inventors.

### FIELD OF INVENTION

This invention relates to biometric technology, specifically how any form of biometric technology can be quickly and efficiently integrated into a host software application.

### BACKGROUND OF THE INVENTION

Due to its unparalleled ability to positively establish and confirm human identity, biometric technology is rapidly being embraced by an increasing number of commercial applications. For example, fitness clubs can simplify the check-in process by replacing membership cards with a fingerprint scan. Banks can safeguard customer accounts by requiring biometric authentication prior to making a transaction. Airports can improve security by comparing a passenger's face or retinal scan against a central watchlist. New uses for biometric technology continue to be explored everyday.

There are two primary components to the biometric recognition process:
1. Enrollment occurs when the biometric recognition software analyzes a person's unique biometric characteristics from an input device or medium. This pattern data is stored in the form of an identity template that can be used to confirm with absolute certainty a person's identity.
2. Comparison occurs when a person's biometric pattern data is compared against the data stored within a database of previously extracted identity templates. The comparison process can consist of identification and verification. With identification, the biometric system asks and attempts to answer the question, “Who is X?” In an identification application, biometric pattern data is compared against every record or identity template in the database. This type of comparison is called a “one-to-many” search (1:N). Verification occurs when the biometric system asks and attempts to answer the question, “Is this X?” after the user claims to be X. In a verification application, the system requires input from a user, at which time the user claims his identity via a password, token, or user name. This user input points the system to a biometric identity template in the database. The system also requires a biometric pattern data sample from the user at that time. It then compares the sample to or against the user-defined template. This is called a “one-to-one” search (1:1).

As the interest in biometric recognition technology expands across various industries it becomes a more valuable system component for many software companies to offer their customers. Currently, the process these companies must go through to integrate a biometric recognition module into their software is extremely cumbersome, time-consuming, and requires a significant amount of software development effort and ongoing support.

Previously, in order to integrate a biometric recognition module, a third party software company had to purchase a biometric recognition SDK (Software Development Kit). An SDK may contain one or more of machine-readable software components such as an object code Dynamic Link Library (DLL), Component Object Model (COM), and object library (.Iib). These biometric technology building blocks enable a software company to develop a solution that meets its specific technology requirements. When performing the integration using such a component, integrators must fully understand every parameter involved with the biometric recognition process. Mapping appropriate data-types, linking libraries, understanding the result of making a function call, storage management for biometric data, and data retrieval and matching are some of the many burdensome parameters integrators must address.

A particular parameter that is critical to the success of a biometric recognition system is its accuracy level. This measurement of a biometric system is expressed in terms of False Accept Rate (FAR) and False Reject rate (FRR). These values are heavily dependent on the quality of data that is enrolled in the system, various system parameters that optimize the specific biometric algorithm, and “non-algorithmic decision-making processes.” These processes allow an integrator's application to determine the most reliable result after a biometric algorithm performs a particular authentication or identification by using multiple samples to test and rank in order of matching accuracy. Using an SDK to develop a highly robust and accurate biometric recognition system is very challenging for many software integrators.

Another problem that concerns many integrators is library dependency: the integrator's software becomes dependent on the biometric technology provider's software component. Integrators can't compile their code without proper libraries from the biometric SDK/API/Component (ActiveX, OCX) provider. Several methods have been proposed to make a general component library more flexible; see for example, U.S. Pat. No. 5,634,114 (Shipley), U.S. Pat. No. 6,665,735 (Tanaka et al) and U.S. Pat. No. 6,499,137 (Hunt).

However, the field of biometrics is very complex and involves the management of many elements, such as biometric data collection devices (e.g. camera, fingerprint scanner, retina scanner, etc.), data storage, and developing new methods for improved reliability. Hence, newer versions are rarely backward compatible. Therefore, if a biometric technology provider changes its library or biometric data collection device, the integrator needs to recompile its software code and in many cases such changes require complete rewriting of the code module that performs the biometric authentication processes. Also, a complete rewriting of the system is needed if the integrator finds a better biometric algorithm, more affordable system alternative, or data collection device, is forced to find a new biometric provider because its previous provider is no longer in business, or is switching to an entirely different and more reliable biometric technology.

In summary, the current process of developing and adding a biometric system requires an integrator to invest substantial engineering resources in learning the intricacies of biometric recognition and writing its own code. Some integrators may be inclined to take on this challenge; however, many others would like to avoid any development and submersing themselves with a completely new technology that is outside of their core competency because it can introduce defects in their own host software. Additionally, supporting a new technology can easily distract the integrator's core focus. Therefore, even though the addition of a biometric module can be extremely beneficial, many companies are very slowly adopting it. Years of dedicated research in areas of biometric technology such as fingerprint and face recognition, retina scanning, hand geometry, and many others have produced very promising solutions. But because of integration and system complexities, these technologies have not been able to be packaged for rapid adoption by commercial software applications.

Therefore, what is greatly needed is an improved method for rapidly integrating biometric functionality to a host software platform that: 1) is runtime and compilation independent; 2) is universal among all forms of biometric technology; 3) eliminates the need to learn a new and complex technology. This method will enable software development companies to immediately capitalize on the benefits of biometric technology, remain focused on their core competencies, avoid extensive time and resource investment in system development and support, easily interchange biometric systems and components if needed, and accelerate the use of biometric technology by end user customers.

### REFERENCES

U.S. Pat. No. 4,151,512 (Riganati, et al)
U.S. Pat. No. 4,322,163 (Schiller)
U.S. Pat. No. 4,537,484 (Fowler, et al)
U.S. Pat. No. 4,747,147 (Sparrow)
U.S. Pat. No. 6,947,579 (Bronstein , et al)
U.S. Pat. No. 6,944,319 (Huang, et al)
U.S. Pat. No. 6,345,109 (Souma, et al)
U.S. Pat. No. RE36,041 (Turk, et al)
U.S. Pat. No. 6,961,450 (Takhiri , et al)
U.S. Pat. No. 6,594,377 (Kim, et al)
U.S. Pat. No. 5,634,114 (Shipley)
U.S. Pat. No. 6,665,735 (Tanaka et al)
U.S. Pat. No. 6,499,137 (Hunt)

### SUMMARY

Accordingly, several objects and advantages of the present invention are:
(a) to enable any software developer to immediately integrate a seamless automated biometrics recognition functionalities into a host software application.
(b) to eliminate system dependencies between the host software and biometrics system so that each can be managed and maintained independently without any changes in one system potentially affecting the other.
(c) to eliminate the need for software developers to invest a significant amount of time and resources in the development of a viable, complete biometrics system using a conventional low level SDK.
(d) to enable software development companies to remain focused on their core applications by avoiding extensive development and support of an integrated biometrics system.
(e) to accelerate time-to-market of an integrated biometrics system for software development companies.
(f) to provide a mechanism that allows an integrator to switch between different biometric technology support without reprogramming.

The present invention includes a method to integrate a completely developed biometric identity recognition system into any third party software application. The resulting integrated system is independent of the host software, allowing both products to be maintained separately, and can consist of any form of biometric technology.

### BRIEF DESCRIPTION OF THE DRAWINGS

The invention may be understood by reference to the following description taken in conjunction with the accompanying drawings, in which, like reference numerals identify like elements, and in which:

FIG. 1. illustrates an overview level diagram of a sample system compatible with the present invention;

FIG. 2. illustrates a flow diagram depicting the steps employed in the method of application software using out of process separate fingerprint software program in accordance with the preferred embodiment of this invention;

FIG. 3. illustrates a description of a list of fingerprints retained by fingerprint software;

FIG. 4. illustrates a flow diagram describing the fingerprint enrollment process steps employed in the embodiment of the invention;

FIG. 5. illustrates a flow diagram describing the fingerprint verification process steps employed in the embodiment of the invention; and

FIG. 6. illustrates a flow diagram describing the fingerprint identification process steps employed in the embodiment of the invention.

### DETAILED DESCRIPTION

For the purpose of this discussion, the term “computer” will generically refer to all computing devices, including personal computers, network computers, bridges, routers, workstations, supercomputers, embedded computer processor chips, etc.

Biometrics is the science of measuring physical properties of living beings. Biometric information includes many different types of personal information including, for example, a user's voice, photograph, hand geometry, retina, palm print and fingerprint. Any form of biometric technology can be used with this invention.

Inter-process communication (IPC) is a set of techniques for the exchange of data between one process and another, either within the same computer or over a network. It implies a protocol that guarantees a response to a request. Examples are Unix sockets, RISC OS's messages, Mach ports, OS/2's named pipes, Microsoft Windows' OLE and DDE, Novell's SPX, Apple Macintosh's IAC (particularly AppleEvents) and Remote Procedure Call (RPC).

Biometric template is a mathematical representation of a biometric sample (i.e. a facial image, fingerprint, retina image). A template enables algorithms to work more quickly than would otherwise be possible by encoding the relevant information in a series of bits and bytes.

Biometric algorithm is a sequence of instructions that tells a system how to solve a problem—used by biometric systems, for example, to tell whether a sample and a template are a match.

Fingerprint recognition, face recognition, hand geometry, and iris recognition technology (including capture device hardware), and image processing and matching technology are relatively mature technologies (see, for example, U.S. Pat. Nos. 4,151,512, 4,322,163, 4,537,484, 4,747,147, 6,947,579, 6,944,319, 6,345,109, RE36,041, 6,961,450, 6,594,377, each of which is incorporated herein by reference for all purposes).

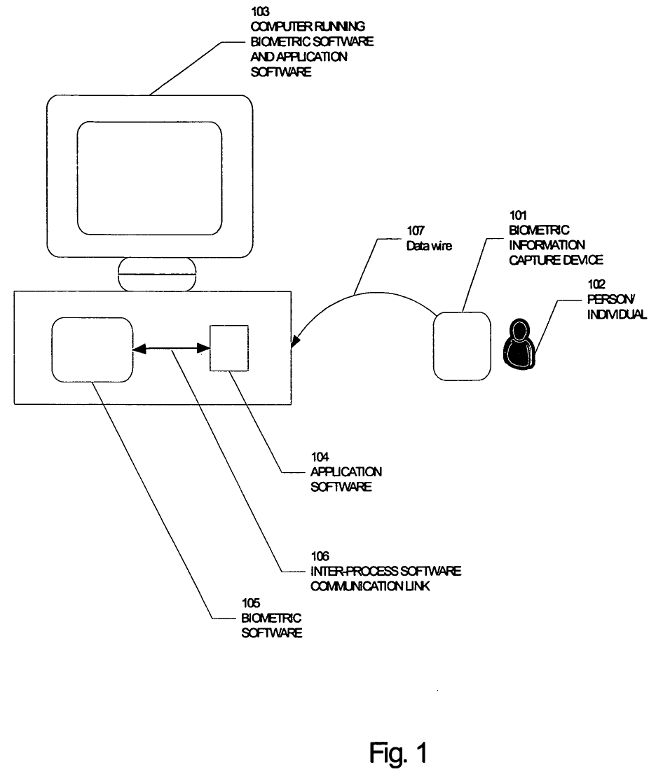

FIG. 1 illustrates an overview level diagram of a sample system in which the present innovation may be implemented. An application software 104 running in a computer 103 desires to have biometrics identification or verification support built into it. But, to keep focused on their core software development area and to avoid dealing with the complicated development of biometric technology inside their application software 104, the manufacturer of application software 104 utilizes the biometrics functionality of biometrics software 105 running in the computer 103. When application software 104 needs to perform some biometrics activities for the individual 102, it sends the request to biometrics software 105 over the software inter-process software communication link (which can be any of the standard inter-process communication methods, such as shared memory, semaphore, socket, Pipe, message queue) 106. Biometrics software 105 then uses biometrics data capture device 101 connected to computer 103 with a data wire 107 to capture biometrics information of individual 102. Biometrics software 105 then captures biometric data (fingerprint, face picture, retina picture, hand image or applicable data for employed biometric) from individual 102 if needed, performs the appropriate request sent by application software 104, and notifies the completion back to application software 104.

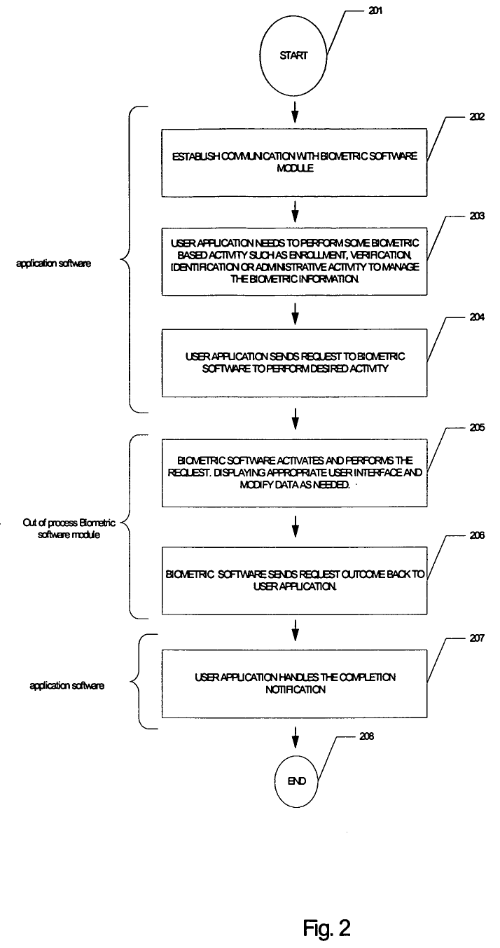

FIG. 2 is a process flow diagram describing the sequences application software 104 and biometric software 105 follow according to the present innovation. The process begins at 201, and in step 202, application software 104 establishes inter-process software communication link 106 with biometric software 105. When application software 104 requires performing any biometric based activity such as enrolling someone into the system, verifying someone's identity based on his/her biometric characteristics, or identifying someone using his/her unique biometric features in step 203, it sends a request to biometric software 105 in step 204. Upon receiving the request in step 205 from application software 104, biometric software 105 displays the appropriate user interface to capture biometric data from the individual 102 and performs the necessary operation as required. In step 206, biometric software 105 sends the outcome of the operation to application software 104 over the inter-process software communication link 106. Upon receiving the status from biometric software 105 in step 207, the application software 104 performs the application specific activities implemented by its manufacturer. The process then concludes at 208.

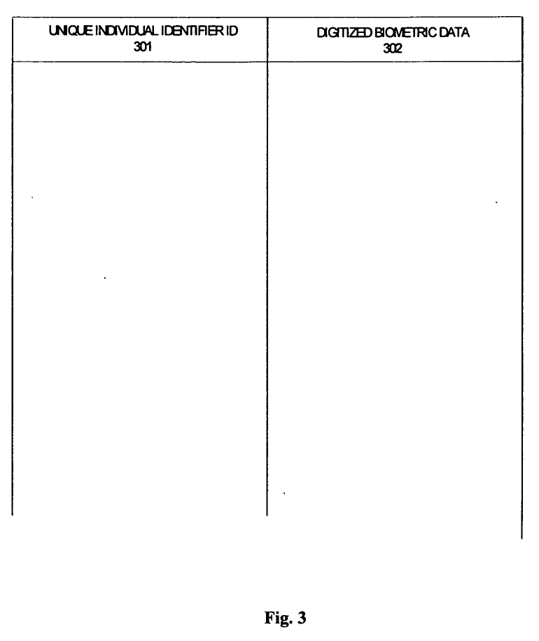

FIG. 3 represents a sample database or tabular list where person's biometric data (biometric template) 302 is saved. Each individual identifier ID 301 is linked with a biometric data 302. The biometric software manages this database.

Biometric based application software usually contains (unless enrollment is done by other software application) functionalities to enroll a person's biometric data in the system, authenticate a person, and identify a person. Enrollment is the process by which an individual's biometric data is added in the system. In the authentication process, biometric data from a person is captured and then it is matched against a previously saved copy of the same person's biometric data. For authentication, the application needs some means to find the individual's previously saved copy of the biometric data. The identification process involves finding a person not known to the system. During the identification process, biometric data is captured from an individual and then searched against all the records in the system to find the potential match.

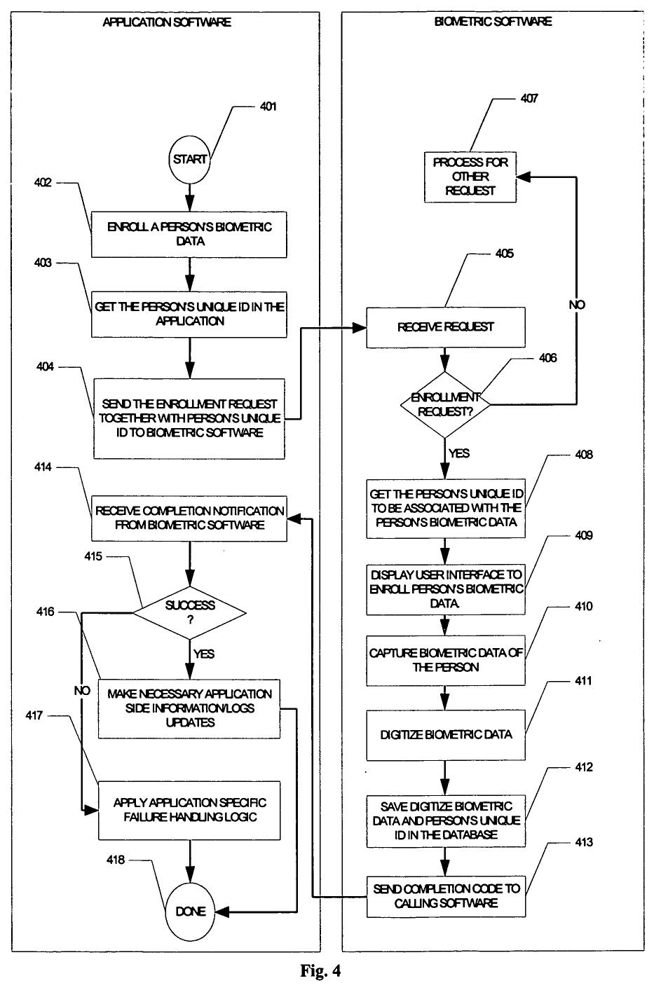

An enrollment process, according to the present innovation initiated by application software 104 is described in FIG. 4. The process starts at 401. In step 402, application software 104 requests to enroll an individual's biometric data in the system. This individual has or will have some kind of unique individual identification ID 301 in the application software 104. In step 403, application software 104 collects the individual's unique ID 301 in system and passes it to biometric software 105 alone with an enrollment request in step 404. The request is passed to biometric software 105 over inter-process software communication link 106. Upon receiving the request in step 405, biometric software 105 checks whether the request is an enrollment request in step 406. If request is not for enrollment, the process moves to step 407 where other types of requests are handled. If an enrollment request is made, in step 408, biometric software 105 isolates the individual's unique identifier ID 301 from the request. The enrollment process may involve a user interface that is shown in step 409 to guide a user through completing the task. In step 410, biometric software 105 captures biometric data using biometric information capture device 102. The captured data is then digitized (called biometric template) in step 411. Digitized biometric data 302 and unique individual identifier ID 301 are saved in the database in step 412. Biometric software 105 then in step 413 sends the completion code, which explains whether the operation was successfully completed and concludes the responsibility of biometric software 105 during the enrollment process. In step 414, application software 104 receives completion code from biometric software 105. Afterwards, application software 104 checks the completion code in step 415. If completion code indicates that the enrollment process was completed successfully by biometric application 105, in step 416, application software 104 performs any necessary updates or tasks according to its manufacturer's implementation and finally concludes the process in step 418. But, if the completion code indicates that the enrollment process was completed unsuccessfully by biometric application 105, in step 417, application software 104 makes any necessary logs or tasks according to its manufacturer's implementation and finally concludes the process in step 418.

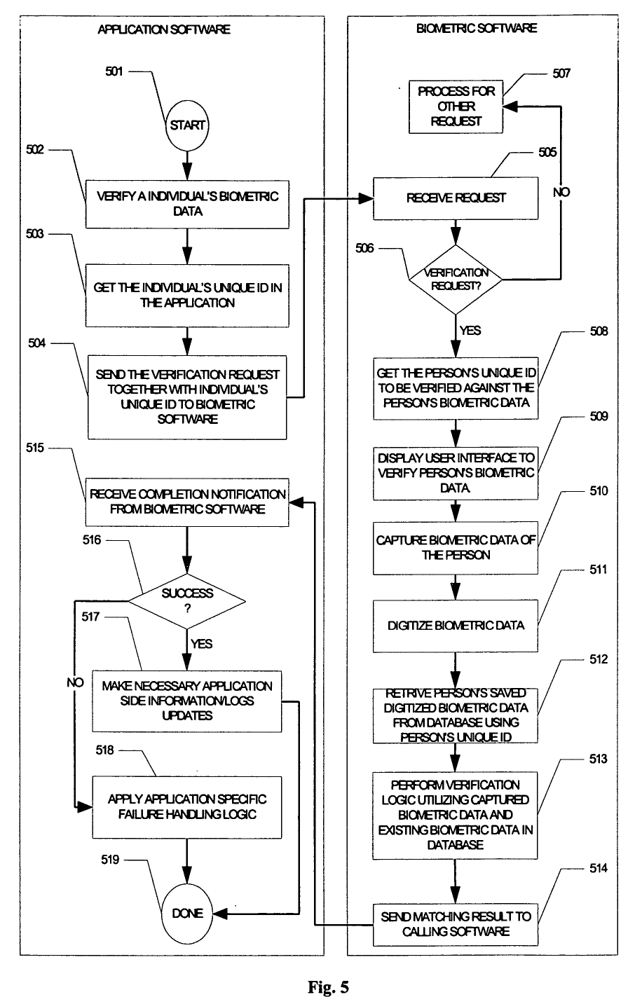

Biometric authentication is a widely used biometric based validation system. FIG. 5 describes the sequences involved in an authentication process according to the present innovation. The process starts at 501. In step 502, application software 104 requires to perform biometric authentication for an individual. Therefore, application software 104 collects the unique individual identifier ID 301 in step 503. In step 504, application software 104 sends the unique individual identifier ID 301 alone with verification request to biometric software 105 over inter-process software communication link 106. In step 505, biometric software 105 receives the request from application software 104 and checks whether a verification request has been submitted in step 506. If the request is not verification request, the process flow moves to step 507 and handles other requests such as enrollment or identification. If the request is a verification request, in step 508, biometric software 105 gets the unique individual identifier ID 301 of the individual to be verified from the request. In step 509, biometrics software 105 displays the necessary user interface for the verification process. In step 510, biometrics software 105 captures the biometric information of the individual 102 using the biometric information capture device 101. The captured biometric information data is then digitized in step 511. In step 512, using the received unique individual identifier ID 301, biometric software 105 retrieves the individual's previously saved digitized biometric data 302 from the database. The recently captured digitized biometric data and previously saved copy of the digitized biometric data 302 is then compared in step 513 according to the biometric technology that is used for actual implementation. In step 514, biometric software 105 sends the verification result back to application software 104 and concludes its responsibility for the verification process. Application software 104 receives the verification result in step 515. In step 516, application software 104 checks the result of the verification. If the individual 102 has been verified successfully, in step 517, application software 104 performs the necessary task according to its manufacturer's implementation and finally concludes the process in step 519. But, if verification fails, in step 518, application software 104 performs the necessary task to address the failure situation according to its manufacturer's implementation and finally concludes the process in step 519.

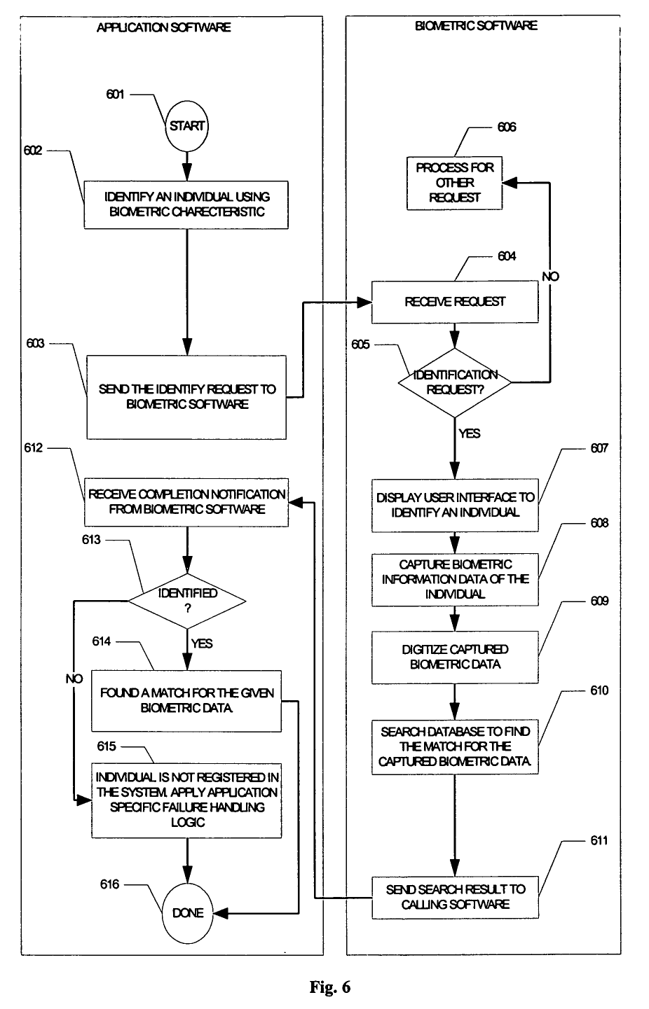

Identification is one of the most desirable functionalities in biometric system. To successfully utilize the identification function, the particular biometric technology being used needs to be very reliable. Fingerprint, face recognition, and iris-based systems are commercially available to reliably perform biometric based identification. Other types of biometric solutions are improving their mechanism to do the same. FIG. 6 describes the sequences involved in an identification process implemented by application software 104 utilizing the functionality from biometric software 105 according to the present innovation. The process starts at 601. In step 602, application software 104 requires to find an individual 102 based on his/her biometric data. Therefore, in step 603, it sends an identification request to biometric software 105 over the inter-process software communication link 106. Biometric software 105 receives the request from application software 104 in step 604. In step 605, biometric software 105 checks whether the request was sent for identification and moves to step 606 if the request is for a different purpose. If an identification request is found in step 606, biometric software 105 moves to step 607. In step 607, the biometric software displays a user interface to perform the identification process. Individual 102's biometric information data is captured in step 608 using the biometric information capture device 101. The captured data is digitized in step 609. In step 610, biometric software 105 compares the digital biometric data captured in step 608 against the entire database of previously saved digital biometric data (FIG. 3 from enrollment process according to FIG. 4). After the search operation is completed, in step 611, biometric software 105 returns the result to application software 104 and thus concludes the responsibility of biometric software 105 for the identification process. Application software 104 receives the result from biometric software 105 in step 612. In step 613, application software 104 checks whether the result from biometric software 105 was a successful identification. If a successful match was found, the process moves to step 614 and application software 104 performs the necessary task according to its manufacturer's implementation and finally concludes the process in step 616. But, if the result indicates a failure in step 613, the process moves to step 615 where application software 104 performs the necessary task to address the failure situation according to its manufacturer's implementation and finally concludes the process in step 616.

1. A method to integrate biometric recognition software into a host software application with runtime and compilation independence, comprising the steps of:
(a) executing host software that does not contain a direct function call to a core biometric technology provider's function;
(b) communicating the host software and biometric recognition software over at least one inter-process communication mechanism supported by an operating system on which the host software and biometric recognition software are running;
(c) executing the biometric recognition software independent of the host software for the purpose of implementing and releasing enhancements and versions;
(d) executing the host software independent of the biometric recognition software for the purpose of implementing and releasing enhancements and versions;
(e) using the biometric recognition software that has been developed using any industry standard biometric technology
(f) executing the host software without the presence of the biometric recognition software and properly performing all of its non-biometric dependent functions

2. The method of claim 1, wherein the method further comprises the step of sending a request by the host software for the biometric recognition software to perform a biometric enrollment procedure, said sending step comprising the steps of:
(a) transmitting a data string identifier by the host software to the biometric recognition software, including a plurality of data segments, associated to a user in the host software;
(b) transmitting a request by the host software, which is represented by a variable, to indicate the host software is requesting an enrollment task

3. The method of claim 1, wherein the method further comprises the step of sending a request by the host software for the biometric recognition software to perform a biometric verification procedure, said sending step comprising the steps of:
(a) transmitting a data string identifier by the host software to the biometric recognition software, including a plurality of data segments, associated to a user in the host software;
(b) transmitting a request by the host software, which is represented by a variable, to indicate the host software is requesting an enrollment task

4. The method of claim 1, wherein the method further comprises the step of sending a request by the host software for the biometric recognition software to perform a biometric identification procedure, said sending step comprising the steps of:
(a) transmitting a data string identifier by the host software to the biometric recognition software, including a plurality of data segments, associated to a user in the host software;
(b) transmitting a request by the host software, which is represented by a variable, to indicate the host software is requesting an enrollment task

5. The method of claim 2, wherein the biometric recognition software returns a return code to the host software indicating one of success or failure of the requested enrollment operation

6. The method of claim 3, wherein the biometric recognition software returns a return code to the host software indicating one of success or failure of the requested verification operation

7. The method of claim 4, wherein, upon a successful comparison attempt of captured digital biometric data, the biometric recognition software returns the associated individual unique identifier to the host software or, upon an unsuccessful comparison attempt of captured digital biometric data returns a failure code on unsuccessful search.

8. The method of claim 1, wherein the host software performs biometric data management operations by sending a request to the biometric recognition software for this function and the biometric software sends a request completion code back to the host software

9. The method of claim 1, wherein the biometric recognition software includes a graphical user interface to display biometric data and wherein a biometric capture device captures biometric information data.

10. The method of claim 1, wherein the biometric recognition software manages the data storage of digitized biometric data.
